(19) United States
(12) Patent Application Publication
(10) Pub. No.: US 2007/0017094 A1
(43) Pub. Date: Jan. 25, 2007

(54) ANODE COPPER BALL FOR PLATING AND METHOD OF MANUFACTURING THE SAME

(75) Inventors: Hideo Takizawa, Saitama-shi (JP); Shoji Nomura, Sakai-shi (JP); Masanori Yunoki, Sakai-shi (JP)

Correspondence Address: DARBY & DARBY P.C., P. O. BOX 5257, NEW YORK, NY, 10150-5257, US

(73) Assignee: Mitsubishi Materials Corporation, Chiyoda-ku (JP)

(21) Appl. No.: 11/277,169

(22) Filed: Mar. 22, 2006

(30) Foreign Application Priority Data
Mar. 25, 2005 (JP) 2005-088738
Feb. 20, 2006 (JP) 2006-042334

(51) Int. Cl. H01R 43/16; H01R 43/04; B21B 1/46

(52) U.S. Cl. 29/882; 29/874; 29/527.1

(57) ABSTRACT

A method of manufacturing an anode copper ball for plating by forging in an oilless state, and to minimize flat portions existing on the surface of the ball to improve the rolling property of the ball. Manufacturing an anode copper ball for plating which forms a ball by subjecting a copper rod to cold multi-stage forging by a metal mold composed of a plurality of sets of dies and punches. The method includes a first forging step of forging the copper rod in a direction of its axis without being brought into pressure contact with an inner wall surface of the die, to thereby form a first intermediate material in which outer peripheral portions of end faces of the copper rod are pressed and formed as tapered faces. The first intermediate material is formed in the shape of a ball through the first forging step.

### BACKGROUND OF THE INVENTION

The present application claims priority under U.S.C. §119 to Japanese Patent Application Nos. 2005-088738, filed Mar. 25, 2005 and 2006-042334, filed Feb. 20, 2006. The content of these applications are incorporated herein by reference in their entireties.

1. Field of the Invention

The present invention relates to a method of manufacturing an anode copper ball for plating used as a copper raw material in electrolytic plating of copper.

2. Description of the Related Art

Conventionally, as a method of plating copper on a printed wiring board of portable telephones, computers, etc., there is widely used electrolytic plating in which copper is used as an anode electrode, a printed circuit board is used as a cathode electrode, and these electrodes are dipped in a plating bath of a diluted sulfuric solution, etc., and supplied with an electric current. In this electrolytic plating, the copper used as the anode electrode is eluted, and the eluted copper is plated on the surface of the printed wiring board used as the cathode electrode.

There is another method in which, as the anode electrode of a copper material for the electrolytic plating, a copper material which is formed in the shape of a ball (anode copper ball for plating) is used, a basket made of a corrosion-resistant material, such as titanium (Ti), is disposed in the plating bath, and the anode copper balls for plating are sequentially loaded into the basket. Since the copper material is melted in a solution, it gradually wears out. In accordance with the amount of the wear, an anode copper ball for plating can be rolled and loaded into the TI basket. Thus, the electrolytic plating can be performed continuously.

The anode copper ball for plating is made of low oxygen copper whose oxygen content is 20 ppm or less, phosphorous deoxidized copper, etc, and the anode copper ball is manufactured by rotary forming these kinds of copper materials. Even though the anode copper ball for plating manufactured by the rotary forming has a high degree of sphericity and excellent rolling property, crystal grains of the anode copper ball are coarsened because the ball is heated during the rolling process, which results in an increase in the amount of sludge.

As another method of manufacturing an anode copper ball for plating, a method of forging a substantially cylindrical copper rod at one stage can be exemplified. However, this method has a problem in that flat portions of a ball may remain large, which deteriorates the rolling property of the copper ball.

Thus, as a method of forming the ball not by one-stage forging but by multi-stage forging, there is known a method disclosed in JP-A-2003-181590. In this method, an intermediate material whose entire shape is substantially barreled is formed by upset-forging a cylindrical material in the direction of its axis, and the intermediate material is provided to a finish forging step through which the intermediate material is forged by a punch having a hemispherical cavity at its tip face and a die facing the punch and having a hemispherical cavity.

According to the above method, since the barreled intermediated material is forged by the die and the punch, each having a hemispherical cavity, metal can be filled into a metal mold formed by the die and the punch, thereby forming a ball.

Meanwhile, the method disclosed in JP-A-2003-181590 is aimed at forming ball bearings, etc., made of steel products having a relatively high hardness. Forming a ball made of a soft material such as copper is not considered in the method.

Here, a cylindrical material can be obtained by shearing a wire having a predetermined diameter at an appropriate length. In this connection, in a case in which a steel product is sheared, a cut face is formed as a face substantially perpendicular to a peripheral face of the cylindrical material. Accordingly, when the cylindrical material is forged, the axis of the cylindrical material can be made to coincide with the axis of the die and the punch. As a result, forging can be performed well and thereby a ball can be formed.

On the other hand, in a case in which a soft material such as copper is sheared, a portion of a cut face of the material is drawn by shearing. As a result, there was a problem in that the cut face is inclined with respect to the peripheral face of the cylindrical material. If the material whose cut face is inclined with respect to the peripheral face as such is upset-forged, the axis of the cylindrical material and the axis of the die and the punch do not coincide with each other. As a result, there was a problem in that the ball cannot be formed.

Further, the cut face is work-hardened due to the distortion during the shearing, which locally deteriorates the ductility of the cut face. In the case in which such a cylindrical material whose cut face is work-hardened by the die and the punch each having the hemispherical cavity is forged, metal does not flow smoothly into the cavities because of the ductility of the cut face is low, and thereby large flat portions are formed in central portions of the cavities, that is, portions to be central portions of the end faces. As a result, a ball cannot be formed.

Further, since the anode copper ball for plating is used while it is dipped in the plating bath as described above, in the case in which oil adheres to the surface of the copper ball, the oil may contaminate the interior of the plating bath, which causes various troubles in the operation of the plating process, such as hindrance of the operation due to the necessity for cleaning of the plating bath, occurrence of defective plating due to adhesion of foreign matters, and the like.

Thus, the forging step of forming an anode ball for plating is preferably performed in an oilless state without feeding oil into a metal mold composed of a die and a punch.

However, in a case in which forging is performed in an oilless state, if the filling ratio within the metal mold increases to bring a forged material into strong pressure-contact with the inner wall surface of the metal mold, it is difficult to be rejected the forged material from the metal mold. Therefore, it is necessary to decrease the filling ratio. In the method described in JP-A-2003-181590, in the case in which a ball is formed by cold forging in a state where the filling ratio is low, the copper within the metal mold is insufficiently packed. As a result, there was a problem in that a ball cannot be formed.

Further, in JP-A-2003-181590, a ring-shaped burr is formed on the peripheral face of the ball and therefore it is necessary to remove the burr by a cutting process, etc. However, since oil is used during the cutting process, there was a problem in which the above method cannot be applied in forming an anode copper ball for plating, which avoids adulteration of oil. Further, since the burr is removed, there was a problem in that the yield of the material is low, and the manufacturer's cost increases.

The invention has been made in consideration of the above circumstances. It is therefore the object of the invention to provide an anode copper ball for plating and a method of manufacturing the anode copper ball for plating which makes it possible to stably manufacture the anode copper ball for plating even if the anode copper ball is formed by cold-forging in an oilless state, and to minimize flat portions existing on the surface of the ball to improve the rolling property of the ball.

### SUMMARY OF THE INVENTION

In order to achieve the object, according to an aspect of the invention, a method of manufacturing an anode copper ball for plating in which a cold multi-stage forging is performed by a metal mold composed of a plurality of sets of dies and punches to form a ball from a copper rod, includes: a first forging step of forging the copper rod in a direction of its axis without being brought into pressure against with an inner wall surface of the die, to form a first intermediate material in which outer peripheral portions of end faces of the copper rod are crushed and formed as tapered faces. The first intermediate material is formed in the shape of a ball through the first forging step.

In the above manufacturing method, bending, etc., of the end faces of the copper rod is corrected by the first forging step. Further, since the first intermediate material is forged without being brought into pressure contact with the inner wall face of the die, it is not strongly fixed within the metal mold. In addition, the above expression “without being brought into pressure contact with the inner wall face” means that the case, when material comes in contact with the inner wall face of the metal mold to such an extent that it is not strongly fixed to the inner wall face, is not excluded.

Preferably, the method of manufacturing an anode copper ball for plating further includes: a second forging step of pressing the inside of the tapered faces of the first intermediate material in the shape of a ring without being brought into pressure contact with the inner wall surface of the die, to form a second intermediate material having axially protruding protrusions on central portions of the end faces thereof, after the first forging step. The second intermediate material is formed in the shape of a ball through the second forging step. Accordingly, the second intermediate material having the central portions of the end faces thereof is finally provided to a finish forging step of forming a ball. Further, since the second intermediate material is forged without being brought into pressure contact with the inner wall face of the die, it is not strongly fixed within the metal mold.

Here, the tapered faces formed in the first forging step are used as guides for allowing the first intermediate material to be disposed at the center of the metal mold when the first intermediate material is forged in the second forging step.

Further, after the second forging step, the central portions of the second intermediate material in the direction of its axis are forged in the axial direction and formed in the shape of a ball without being brought into pressure contact with the metal mold. Therefore, a ball having few flat faces is formed and a space is defined in an equator portion of a spherical cavity defined by the die and the punch. As a result, the inner faces of the die and the punch become smaller than the hemispherical faces, and the openings of the die and the punch have shapes that extend outwardly.

Further, according to another aspect of the invention, an anode copper ball for plating is manufactured by performing a cold multi-stage forging by means of a metal mold composed of a plurality of sets of dies and punches to form a ball from a copper rod. The cold multi-stage forging is performed in an oilless state.

Since the anode copper ball for plating is manufactured by cold multi-stage forging in an oilless state, the content of the oil on the surface of the anode copper ball for plating is reduced, and coarsening of crystal grains of the ball is suppressed.

Since the above method of manufacturing an anode copper ball for plating has the first forging step of forming the tapered faces at the outer peripheral portions of the end faces, even if the shape of the end faces of the copper rod as a raw material is obliquely formed by shearing, the first intermediate material in which the tapered faces are formed at the outer peripheral portions of the end faces is formed, and the tapered faces are used as guides. As a result, in the subsequent forging, the axis of the first intermediate material can be made to coincide with the axis of the die or the punch, stable forging can be formed, and the ball can be formed.

Further, since the first intermediate material is not strongly fixed within the metal mold, even if forging is not performed in an oilless state, the first intermediate material can be easily separated from the metal mold.

Furthermore, in the second forging step, the inside of the tapered faces formed in the first forging step is pressed in the shape of a ring. At this time, since the area of contact among the portion of the first intermediate material pressed in the shape of a ring and the die and the punch is small, the material that is pressed without applying a force that may be generated when the entire first intermediate material is formed in the shape of a barrel is not applied, flows into the inside of the ring-shaped pressed portion, that is, toward the central axis of the ball, which causes the material to be extruded. The extruding deformation can extrude on the flat face at the top of the ball to improve the sphericity of the ball.

Further, in the finish forging step of finally forming an anode copper ball for plating, when forging is performed by the die having the semispherical cavity at its end face and the punch facing the die and having the semispherical cavity. At this time, the second intermediate material having protrusions on the central portions of the end faces thereof is provided to the finish forging step. Thus, when the hemispherical die and punch are brought close to each other, the protrusion of the second intermediate material is disposed at the center of the hemispherical cavity formed in the die or the punch, and the protrusion is pressed by the central portion of the semispherical cavity, whereby copper flows into the central portion. Thus, a ball having few flat portions can be formed.

Moreover, since the inner faces of the die and the punch becomes smaller than the hemispherical faces, and the openings of the die and the punch have shapes that extend outwardly, even if forging is performed without feeding oil into the metal mold, the ball can be easily removed from the die and the punch.

Further, since a ring-shaped burr is not formed on the peripheral face of the ball after forging, a cutting process becomes unnecessary, and the yield of the material can be improved, and the manufacturer's cost of the ball can be reduced.

Further, according to the anode copper ball for plating in accordance to the invention, since the content of the oil on the surface of the anode copper ball for plating is reduced, contamination of a plating bath due to the oil can be suppressed to prevent occurrence of troubles during the plating operation. Further, since coarsening of crystal grains of the anode copper ball for plating is suppressed, generation of sludge can be suppressed.

As described above, according to the invention, it is possible to provide an anode copper ball for plating and a method of manufacturing the anode copper ball for plating which makes it possible to stably manufacture the anode copper ball for plating even if the anode copper ball is formed by cold-forging in an oilless state, and to minimize flat portions existing on the surface of the ball to improve the rolling property of the ball.

### BRIEF DESCRIPTION OF THE DRAWINGS

FIG. 1 is a side view of a copper rod used in a manufacturing method according to an embodiment;

FIG. 2 is a side view showing a first forging step according to the embodiment;

FIG. 3 is a side view of a first intermediate material formed by the manufacturing method according to the embodiment;

FIG. 4 is a side view showing a second forging step according to the embodiment;

FIG. 5 is a side view of a second intermediate material formed by the manufacturing method according to the embodiment;

FIG. 6 is a side view showing a finish forging step according to the embodiment; and

FIG. 7 is a side view of a ball formed by the manufacturing method according to the embodiment.

### DESCRIPTION OF THE PREFERRED EMBODIMENTS

Hereinafter, an embodiment of the invention will be described with reference to drawings.

FIGS. 1 to 7 show shapes of a copper rod, a first intermediate material, a second intermediate material, and a ball according to the embodiment, and schematically show dies and punches used in a first forging step, a second forging step, and a finish-forging step according to the embodiment in the process order.

As a raw material used in a method of manufacturing an anode copper ball for plating, a copper rod 11 having a cylindrical external shape as shown in FIG. 1 is supplied. This copper rod 11 is made of, for example, low oxygen copper whose oxygen content is 20 ppm or less, or phosphorous deoxidized copper in which phosphorous of 350 ppm to 600 ppm is contained as a deoxidizing agent. The copper rod is also manufactured by continuously casting an ingot by means of a belt-caster type continuous casting machine, rolling the obtained ingot by a continuous rolling mill to make a coiled wire having a predetermined outer diameter (about 39 mm in this embodiment), and shearing the wire at a predetermined length (about 77 mm in this embodiment).

When the wire made of the low oxygen copper or phosphorous deoxidized copper is sheared, portions of cut faces of the wire are drawn by the shearing, whereby the cut faces of the wire, that is, end faces 11a and 11b of the copper rod 11 are formed obliquely with respect to the peripheral face 11c of the copper rod. Since the shapes of the cut faces change greatly depending on cutting conditions, the copper rod 11 has various shapes, not a consistent shape.

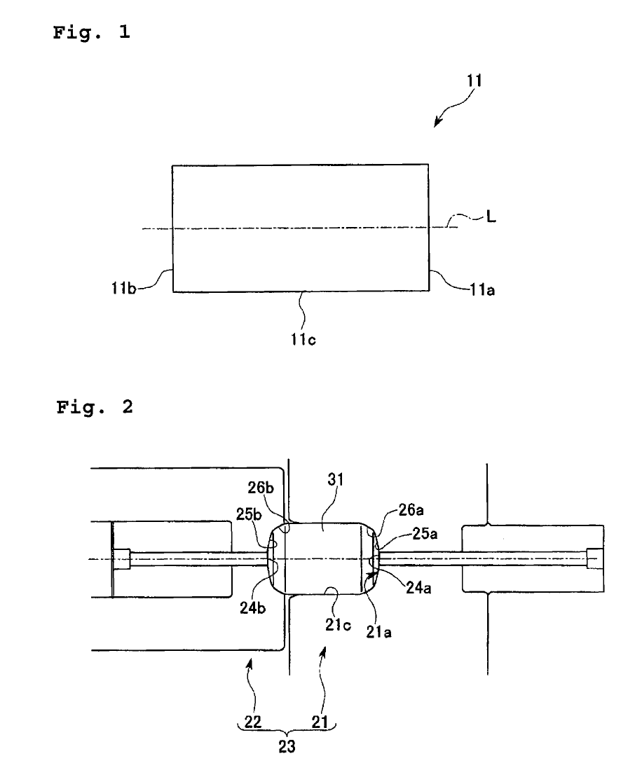

Thus, in a first forging step shown in FIG. 2, the copper rod 11 is inserted into a metal mold 23, which is composed of a die 21 having a deep cylindrical cavity and a punch 22 having a shallow tray-shaped cavity, such that the end faces 11a and 11b thereof face the die 21 and the punch 22, respectively, and the copper rod 11 is then forged in the direction of an axis L of the copper rod 11, whereby the first intermediate material 31 is formed.

A central portion of a bottom portion 21a the die 21 is provided with a planar portion 24a. An outer peripheral portion of the planar portion is provided with a first tapered portion 25a which is gradually flared toward an opening of the die 21. An outer peripheral portion of the first tapered portion 25a is provided with a second tapered portion 26a which is gradually flared toward the opening of the die 21. The taper angle of the second tapered portion 26a is made smaller than that of the first tapered portion 25a. An inner peripheral face 21c of the die 21 extends substantially parallel to the axis of the die 21 so as to be connected to the second tapered portion 26a.

Further, the punch 22 is formed with a planar portion 24b, a first tapered portion 25b, and a second tapered portion 26b which are respectively formed in the same shapes as the planar portion 24a, the first tapered portion 25a, and the second tapered portion 26a which are provided in the bottom portion 21a of the die 21 so as to face the bottom portion 21a of the die 21.

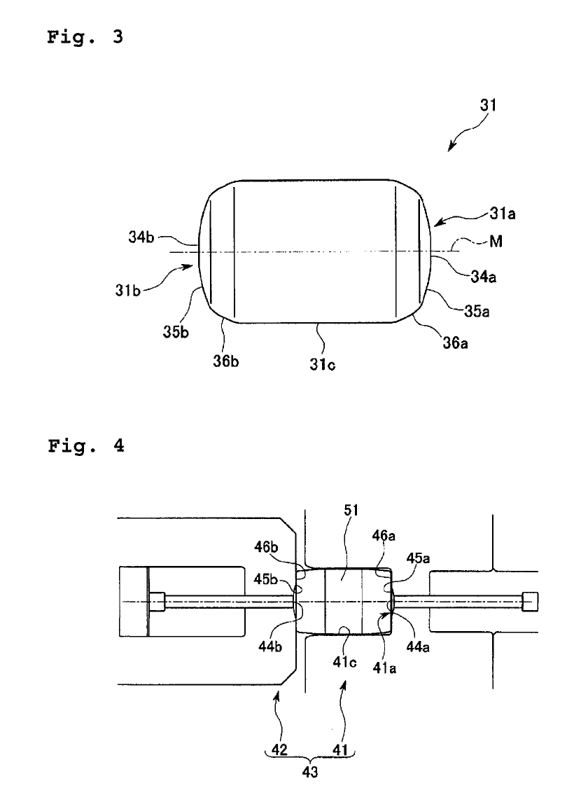

Accordingly, as shown in FIG. 3, central portions of end faces 31a and 31b of the first intermediate member 31 to be formed by the first forging step are formed with flat faces 34a and 34b, respectively. Outer peripheries of the flat faces 34a and 34b are formed with first tapered faces 35a and 35b, respectively. Outer peripheries of the first tapered faces 35a and 35b are formed with second tapered faces 36a and 36b which are connected to a peripheral face 31c of the first intermediate material 31. Further, the copper rod is forged in the direction of the axis L of the copper rod 11, whereby the first intermediate material 31 has its external shape formed in a substantial barrel shape.

Here, in the first forging step shown in FIG. 2, the copper rod is forged so as not to be brought into pressure contact with the inner peripheral face 21c of the die 21 (metal mold 23), and the peripheral face 31c of the first intermediate material 31 is in a state in which it is not strongly pressed against the inner peripheral face 21c of the die 21. Further, in the first forging step, the forging is performed in an oilless state in order to prevent adhesion of oil to the first intermediate material 31.

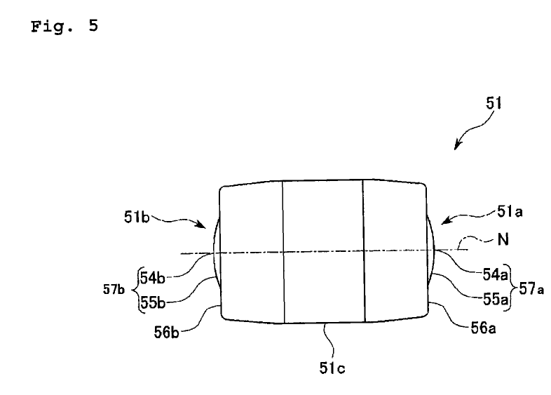

Next, in a second forging step shown in FIG. 4, the first intermediate material 31 is inserted into a metal mold 43, which is composed of a die 41 having a deep cylindrical cavity and a punch 42 having a shallow tray-shaped cavity, such that the end faces 31a and 31b thereof face the die 41 and the punch 42, respectively, and the first intermediate material 31 is then forged in the direction of an axis M of the first intermediate material 31, whereby the second intermediate material 51 is formed.

A central portion of a bottom portion 41a of the die 41 is provided with a planar portion 44a. An outer peripheral portion of the central portion is formed with a concave curved face 45a, which is formed in the shape of a concave curved face. An outer peripheral portion of the concave curved face 45a is formed with an annular planar portion 46a perpendicular to the axis of the die 41. An inner peripheral face 41c of the die 41 extends substantially parallel to the axis of the die 41 so as to be connected to the annular planar portion 46a.

Further, the punch 42 is formed with a planar portion 44b, a concave curved face 45b, and an annular planar portion 46b which are respectively formed in the same shapes as the planar portion 44a, the concave curved face 45a, and the annular planar portion 46a which are provided at the bottom portion 41a of the die 41 so as to face the bottom portion 41a of the die 41.

Accordingly, as shown in FIG. 5, central portions of end faces 51a and 51b of the second intermediate member 51 to be formed in the second forging step are formed with flat faces 54a and 54b, respectively. Outer peripheries of the flat faces 54a and 54b are formed with convex curved faces 55a and 55b, respectively. Outer peripheries of the convex curved faces 55a and 55b are formed with annular planar faces 56a and 56b, which are connected to a peripheral face 51c of the second intermediate material 51. The planar faces 54a or 54b and the convex curved faces 55a or 55b constitute protrusions 57a and 57b.

Here, in the second forging step shown in FIG. 4, the first intermediate material is forged so as not to be brought into pressure contact with the inner peripheral face 41c of the die 41 (metal mold 43), and the peripheral face 51c of the second intermediate material 51 is in a state in which it is not strongly pressed against the inner peripheral face 41c of the die 41. Further, in the second forging step, forging is performed in an oilless state in order to prevent adhesion of oil to the second intermediate material 51.

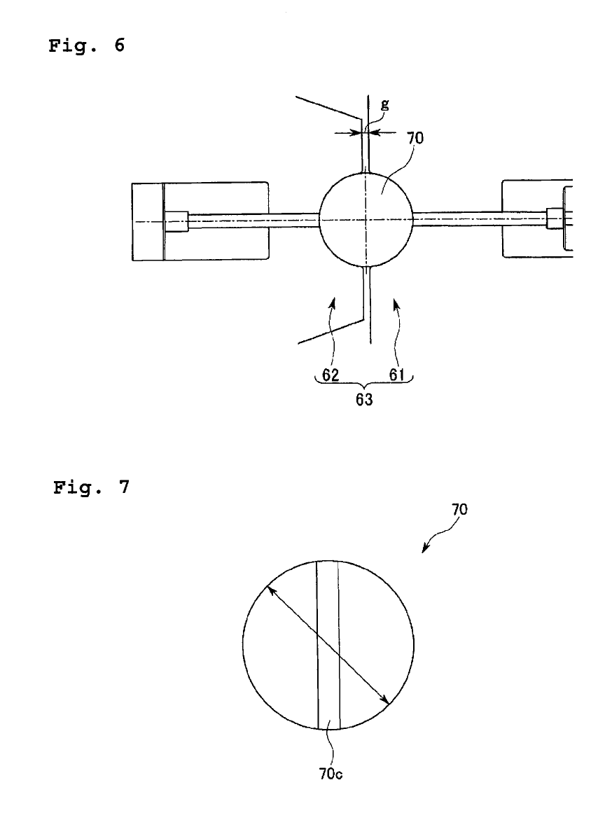

Next, in a finish forging step shown in FIG. 6, the second intermediate material 51 is inserted into a metal mold 63, which is composed of a die 61 having a hemispherical cavity and a punch 62 facing the die and having a hemispherical cavity, and the second intermediate material 51 is then forged in the direction of an axis N of the second intermediate material 51, whereby the ball 70 having an outer diameter of about 55 mm is formed as shown in FIG. 7. In the finish forging step, the forging is performed in an oilless state in order to prevent adhesion of oil to the ball 70.

Here, as shown in FIG. 6, the second intermediate material is forged in a state in which a space g is defined between the die 61 and the punch 62 so that the die 61 and the punch 62 do not come in contact with each other. Accordingly, a central portion of the peripheral face 51c of the second intermediate material 51 does not come in contact with the die 61 and the punch 62, whereby an equator portion of the ball 70 is formed with a ring portion 70c as shown in FIG. 7.

Also, the above-described first forging step, second forging step, and finish forging step are all performed in a cold state.

The anode copper ball for plating manufactured as described above is supplied into a titanium basket disposed within a plating bath in which a diluted sulfuric acid solution is stored, and is then used as an anode electrode. By dipping a printed circuit board serving as a cathode electrode into the plating bath and applying an electric current to the board, the anode copper ball is melted in the diluted sulfuric acid solution, Whereby a copper plating is formed on the surface of the printed circuit board. Here, the anode ball for plating is rolled and supplemented into the titanium basket disposed within the plating bath, whereby the copper plating is continuously performed.

In the above method of manufacturing an anode copper ball for plating, the first intermediate material 31 is formed by the first forging step which forms the tapered faces 35 and 36 at the outer peripheral portions of the end faces of the first intermediate material. Accordingly, even if the shape of the copper rod 11 supplied for forging is not consistent, the tapered faces 35 and 36 are used as guides in the second forging step after the first forging step. As a result, since the axis of the first intermediate material 31 can be made to coincide with the axis of the die 41 or the punch 42, it is possible to form the ball by stable forging.

Further, in the first forging step, forging is performed in an oilless state in order to prevent adhesion of oil to the first intermediate material 31. However, since the copper rod is forged so as not to be brought into pressure contact with the inner peripheral face 21c of the die 21 (metal mold 23), the peripheral face 31c of the first intermediate material 31 is not strongly pressed against the inner peripheral face 21c of the die 21. For example, the planar portion 24a of the bottom portion 21a of the die 21 is provided with a hole through which an eject pin is loaded to press the end face of the first intermediate material 31, whereby the first intermediate material 31 can be easily separated from the metal mold.

Further, in the above method of manufacturing an anode copper ball for plating, the second intermediate material 51 having the protrusions 57a and 57b on the central portions of the end faces thereof is formed by the second forging step. Thus, when forging is performed in the finish forging step by the die 61 having the hemispherical cavity and the punch 62, which faces the die and has the hemispherical cavity, the protrusions 57a and 57b are disposed on the central portions of the hemispherical cavities and the protrusions 57a and 57b are pressed by the central portions of the hemispherical cavities, whereby copper flows into the central portions. Thus, a ball having few flat portions can be formed.

Further, in the second forging step, forging is performed in an oilless state in order to prevent adhesion of oil to the second intermediate material 51. However, since the first intermediate material is forged so as not to be brought into pressure contact with the inner peripheral face 41c of the die 41 (metal mold 43), the peripheral face 51c of the second intermediate material 51 is not strongly pressed against the inner peripheral face 41c of the die 41. For example, the planar portion 44a of the bottom portion 41a of the die 41 is provided with a hole through which an eject pin is loaded to press the end face of the second intermediate material 51, whereby the second intermediate material 51 can be easily separated from the metal mold.

Accordingly, in the above method of manufacturing an anode copper ball for plating, the anode copper ball for plating can be stably rolled and reliably supplemented into the titanium basket, whereby it is possible to provide the anode copper ball, which enables copper plating to be continuously performed.

Moreover, since the anode copper ball for plating is manufactured by cold forging, generation of sludge can be suppressed without coarsening crystal grains of the anode copper ball for plating.

In addition, although the present embodiment has been described in conjunction with the method of forming a ball by three-stage forging, the invention is not limited thereto. For example, a plurality of forging steps can be performed between the first forging step and the second forging step.

Further, although the present embodiment has been described in conjunction with the methods of manufacturing the copper rod 11 by using a belt-caster type continuous machine and a continuous rolling mill, the copper rod may be manufactured by using any method other than the above methods. For example, it is possible to use a method in which a wire is manufactured by extruding a billet material at high temperature and the wire is cut.

### EXAMPLE 1

Evaluation experiments were carried out to confirm the effects of the invention. The results are shown below. In Comparative Experiment 1, the amount of oil on the surfaces of anode copper balls for plating was evaluated. As the example of the invention, an anode copper ball manufactured by the manufacturing method that is the above-mentioned embodiment was provided to the experiments. As Comparative Example 1, an anode copper ball manufactured by performing forging during feeding of oil was provided to the experiments.

These anode copper balls for plating were dipped in the solvent “H997” (Horiba Co., Ltd.), the oil on the surfaces of the anode copper balls for plating was extracted, and the H—C bonds of the solvent H997 were measured by an FT-IR (Fourier Transform Infrared Spectrophotometer) to evaluate H—C bonds as the contents of oil.

These results are shown in Table 1.

TABLE 1

| | Content of Oil |
|---|---|
| Example of Invention | 0.0002 mg/cm² |
| Comparative Example 1 | 0.0010 mg/cm² |

The surface oil amount of the example of the invention on which forging was carried out is reduced to one fifth of that of the comparative example. According to the invention, it was confirmed that it is possible to provide the anode copper ball, which minimizes possible contamination within the plating bath.

### EXAMPLE 2

Next, the amount of sludge was evaluated in Comparative Example 2. As the example of the invention, an anode copper ball manufactured by the manufacturing method that is the above-mentioned embodiment was provided to the experiments. As Comparative Example 2, an anode copper ball manufactured by performing forging was provided to the experiments.

An anode copper ball for plating having a diameter of 55 mm was hung from a Ti bar and dipped in a sulfate bath having a bath amount of 1500 ml and a bath temperature of 30° C., a brass plate was used as a negative electrode, and the surface area of the negative electrode was set to 0.95 dm², and the surface area of the negative electrode was set to 0.6 dm². Under these conditions, electrolytic plating was carried out for 24 hours while a current value is maintained at 3.6 mA. Then, sludge precipitated in the bottom of the electrolytic bath was collected and dried, and the weight of the sludge was measured and evaluated.

The evaluation results are shown in Table 2.

TABLE 2

| | Weight of Sludge |
|---|---|
| Example of Invention | 100 mg |
| Comparative Example 2 | 150 mg |

The sludge amount of the example of the invention manufactured by cold forging is reduced to two-thirds of that of the comparative example. According to the invention, it was confirmed that the amount of sludge could be reduced.

What is claimed is:

1. A method of manufacturing an anode copper ball for plating in which a cold multi-stage forging is performed by a metal mold composed of a plurality of sets of dies and punches to form a ball from a copper rod, comprising the steps of:
forging the copper rod in a direction of its axis without being brought into pressure against with an inner wall surface of the die, and
forming a first intermediate material in which outer peripheral portions of end faces of the copper rod are pressed and formed as tapered faces,
wherein the first intermediate material is formed in the shape of a ball through the first forging step.

2. The method of manufacturing an anode copper ball for plating according to claim 1, further comprising the steps of:
pressing the inside of the tapered faces of the first intermediate material in the shape of a ring without being brought into pressure contact with an inner wall surface of the die, and
forming a second intermediate material having axially protruding protrusions on central portions of the end faces thereof, after the forging step,
wherein the second intermediate material is formed in the shape of a ball through the second forging step.

3. The method of manufacturing an anode copper ball for plating according to claim 2 further comprising the step of,
forging the central portions of the second intermediate material in the direction of its axis in the axial direction and formed in the shape of a ball, after the pressing.

4. An anode copper ball for plating manufactured by performing a cold multi-stage forging by means of a metal mold composed of a plurality of sets of dies and punches to form a ball from a copper rod,
wherein the cold multi-stage forging is performed in an oilless state.
